(19) United States
(12) Patent Application Publication
(10) Pub. No.: US 2025/0251128 A1
(43) Pub. Date: Aug. 7, 2025

(54) COMBUSTION SYSTEM

(71) Applicant: IHI Corporation, Tokyo (JP)

(72) Inventors: Soichiro KATO, Tokyo (JP); Shintaro ITO, Tokyo (JP)

(73) Assignee: IHI Corporation, Tokyo (JP)

(21) Appl. No.: 19/190,022

(22) Filed: Apr. 25, 2025

Related U.S. Application Data
(63) Continuation of application No. PCT/JP2023/034732, filed on Sep. 25, 2023.

(30) Foreign Application Priority Data
Oct. 28, 2022 (JP) 2022-173338

(51) Int. Cl. F23N 1/00; B01J 19/00; B01J 19/24; C01B 3/04; F23C 1/00; F23D 23/00; F23N 5/00; F23N 5/24

(52) U.S. Cl. CPC F23N 1/002; B01J 19/0006; B01J 19/24; C01B 3/047; F23C 1/00; F23D 23/00; F23N 5/003; F23N 5/242; B01J 2219/00164; F23C 2900/9901; F23N 2225/04; F23N 2229/00; F23N 2900/05003

(57) ABSTRACT

The combustion system includes an ammonia supply source, a cracker that is connected to the ammonia supply source and that decomposes ammonia into hydrogen and nitrogen, a combustor that is connected to the ammonia supply source and the cracker and that combusts ammonia from the ammonia supply source and gas including hydrogen from the cracker, a sensor that detects a combustion abnormality in the combustor, and a controller that is communicatively connected to the sensor and that adjusts an amount of gas from the cracker to the combustor based on a detection result of the sensor.

### CROSS REFERENCE TO RELATED APPLICATIONS

This application is a continuation application of International Application No. PCT/JP2023/034732, filed on Sep. 25, 2023, which claims priority to Japanese Patent Application No. 2022-173338 filed on Oct. 28, 2022, the entire contents of which are incorporated herein by reference.

### BACKGROUND ART

### Technical Field

The present disclosure relates to a combustion system.

Ammonia is known as a fuel that does not emit CO₂. For example, Patent Literature 1 discloses a gas turbine system that uses ammonia as fuel. The system includes a tank for ammonia and a first combustion chamber. Ammonia in the tank passes through a first mass flow separator, a part of which is directly sent to the first combustion chamber and the rest of which is sent to a first cracker chamber. In the first cracker chamber, ammonia is decomposed into a hydrogen-rich gas mixture including nitrogen, hydrogen and other constituents. The ammonia and the hydrogen-rich gas mixture are injected into the first combustion chamber and combusted. Exhaust gas from the first combustion chamber contains high levels of NOx. Furthermore, the system includes a second combustion chamber. The exhaust gas from the first combustion chamber is routed to the second combustion chamber. The ammonia in the tank passes through a second mass flow separator, a part of which is directly sent to the second combustion chamber and the rest of which is sent to a second cracker chamber. In the second cracker chamber, ammonia is decomposed into the hydrogen-rich gas mixture including nitrogen, hydrogen, and other constituents. The ammonia and the hydrogen-rich gas mixture are injected into the second combustion chamber and combusted. In the second combustion chamber, fuel is combusted at a high equivalent ratio of 1.0 to 1.2. This removes NOx from the exhaust gas from the first combustion chamber.

### CITATION LIST

### Patent Literature

Patent Literature 1: JP 2018-535355 A

### SUMMARY

### Technical Problem

In a combustion system using ammonia, combustion abnormalities such as an increase in NOx in exhaust gas, an increase in ammonia in the exhaust gas, a backfire, or a combustion oscillation may occur. Such combustion abnormalities should be prevented.

The purpose of the present disclosure is to provide a combustion system that uses ammonia as fuel and that can prevent combustion abnormality.

### Solution to Problem

A combustion system according to an aspect of the present disclosure includes an ammonia supply source, a cracker that is connected to the ammonia supply source and that decomposes ammonia into hydrogen and nitrogen, a combustor that is connected to the ammonia supply source and the cracker and that combusts ammonia from the ammonia supply source and gas including hydrogen from the cracker, a sensor that detects a combustion abnormality in the combustor, and a controller that is communicatively connected to the sensor and that adjusts an amount of gas from the cracker to the combustor based on a detection result of the sensor.

The sensor may include a first sensor that is provided in the combustor and that detects a combustion oscillation.

The sensor may include a second sensor that is provided in the combustor and that detects a movement of a flame.

The sensor may include a third sensor that detects NOx in exhaust gas at a location downstream of the combustor.

The sensor may include a fourth sensor that detects ammonia in the exhaust gas at a location downstream of the combustor.

The combustor may include a plurality of burners, and the controller may control operations of the plurality of burners based on the detection result of the sensor.

### Effects

According to the present disclosure, a combustion abnormality can be prevented.

### BRIEF DESCRIPTION OF DRAWINGS

FIG. 1 is a schematic diagram of a gas turbine system according to a first embodiment.

FIG. 2 is a schematic diagram of a combustor in FIG. 1.

FIG. 3 is a flowchart showing operations of the gas turbine system in FIG. 1.

FIG. 4 is a flowchart following FIG. 3.

FIG. 5 is a flowchart following FIG. 3.

FIG. 6 is a flowchart following FIG. 3.

FIG. 7 is a flowchart following FIG. 3.

FIG. 8 is a flowchart showing operations of a gas turbine system according to a second embodiment.

FIG. 9 is a schematic graph showing relationships between an ammonia decomposition rate and each parameter.

### DESCRIPTION OF EMBODIMENTS

Embodiments of the present disclosure will be described in detail below with reference to the accompanying drawings. Specific dimensions, materials, and numerical values described in the embodiments are merely examples for a better understanding, and do not limit the present disclosure unless otherwise specified. In this specification and the drawings, duplicate explanations are omitted for elements having substantially the same functions and configurations by assigning the same sign. Furthermore, elements not directly related to the present disclosure are omitted from the figures.

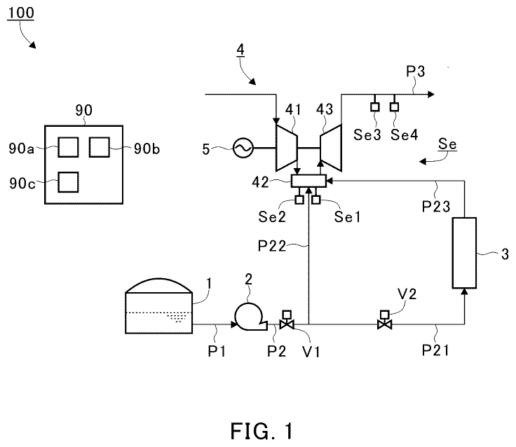

FIG. 1 is a schematic diagram of a gas turbine system 100 according to a first embodiment. In the present embodiment, the gas turbine system 100 functions as a combustion system. In the present disclosure, the gas turbine system 100 may also be referred to simply as “system 100.” For example, the system 100 includes a tank (ammonia supply source) 1, a pressurizer 2, a cracker 3, a gas turbine 4, a generator 5, and a controller 90. The system 100 may further include other components. Furthermore, the system 100 may not include one or more of the above components.

The tank 1 stores ammonia. Specifically, the tank 1 stores liquid ammonia. The tank 1 is connected to the pressurizer 2 by piping P1. Liquid ammonia stored in the tank 1 is supplied to the pressurizer 2 via the piping P1. In another embodiment, for example, an ammonia production device may be used as an ammonia supply source, instead of the tank 1.

The pressurizer 2 pressurizes ammonia from the tank 1. The pressurizer 2 is communicatively connected to the controller 90 by wire or wirelessly, and controlled by the controller 90. Piping P2 is connected to the pressurizer 2. Pressurized ammonia flows out of the pressurizer 2 to the piping P2.

In the present embodiment, ammonia is supplied in a liquid state to the cracker 3 and the gas turbine 4. In this case, for example, the pressurizer 2 may be a pump. In another embodiment, for example, the system 100 may include a vaporizer in the piping P1 or the piping P2, and ammonia may be supplied in a gaseous state to the cracker 3 and the gas turbine 4. When the pressurizer 2 pressurizes gaseous ammonia, for example, the pressurizer 2 may be a compressor.

A valve V1 is provided in the piping P2. The valve V1 is communicatively connected to the controller 90 by wire or wirelessly, and controlled by the controller 90. For example, the controller 90 adjusts a flow rate of ammonia flowing through the piping P2 by controlling a degree of opening of the valve V1 based on power demand and an amount of electricity generated in the generator 5. The piping P2 is branched into piping P21 and piping P22. The piping P21 is connected to the cracker 3, and the piping P22 is connected to the gas turbine 4.

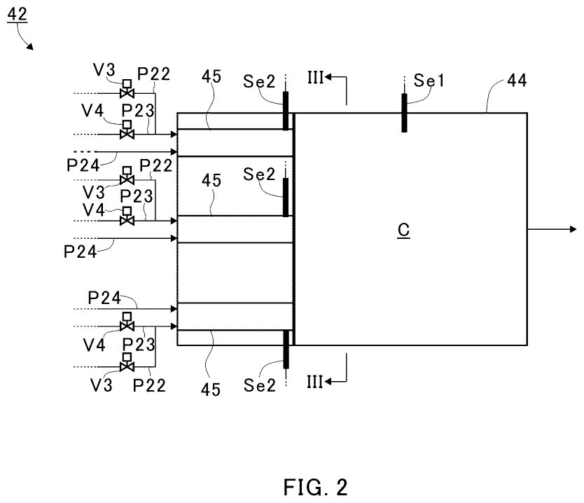

At least a part of the pressurized ammonia is supplied to the gas turbine 4 via the piping P22. Although not shown in FIG. 1, the piping P22 may be branched into a plurality of pipes P22 at the gas turbine 4 to be connected to a plurality of burners 45 (see FIG. 2) which will be described below.

The rest of pressurized ammonia is supplied to the cracker 3 via the piping P21. A valve V2 is provided in the piping P21. The valve V2 is communicatively connected to the controller 90 by wire or wirelessly, and controlled by the controller 90. For example, the controller 90 adjusts a flow rate of ammonia supplied to the cracker 3 by controlling a degree of opening of the valve V2 based on a detection result of at least one of a first sensor Se1, a second sensor Se2, a third sensor Se3 and a fourth sensor Se4 which will be described below.

The cracker 3 decomposes ammonia into hydrogen and nitrogen. The cracker 3 includes a catalyst that decomposes ammonia into hydrogen and nitrogen. Such a catalyst includes, for example, at least one of Ru, Rh, Pt, and Pd. The cracker 3 is connected to the gas turbine 4 by piping P23. Gas including hydrogen and nitrogen (which may also be referred to as “hydrogen-rich gas” in the present disclosure) is supplied from the cracker 3 to the gas turbine 4 via the piping P23. Although not shown in FIG. 1, the piping P23 may be branched into a plurality of pipes P23 at the gas turbine 4 so as to be connected to the plurality of burners 45 (see FIG. 2).

Referring to FIG. 1, the gas turbine 4 includes a compressor 41, a combustor 42, and a turbine 43. The gas turbine 4 may further include other components. The compressor 41 pressurizes air, and sends the pressurized air to the combustor 42.

The combustor 42 is fluidly connected to the tank 1 via the above-described piping P1, P2, and P22. The combustor 42 receives ammonia from the tank 1. The combustor 42 is fluidly connected to the cracker 3 via the above-described piping P23. The combustor 42 receives the hydrogen-rich gas from the cracker 3. In the present embodiment, the combustor 42 combusts ammonia and the hydrogen-rich gas. The combustor 42 may combust other fuels depending on situations.

FIG. 2 is a schematic view of the combustor 42 in FIG. 1. The combustor 42 includes a casing 44 that defines a chamber C, and the plurality of burners 45. The combustor 42 may further include other components such as a liner.

Each burner 45 is arranged so as to face the chamber C. The plurality of burners 45 may be arranged in any pattern, for example, circular, matrix, or polygonal.

Each burner 45 is connected to the above-described piping P22. Each burner 45 is provided with ammonia from the tank 1 via the piping P22. Each pipe P22 is provided with a valve V3. The valves V3 are communicatively connected to the controller 90 by wire or wirelessly, and controlled by the controller 90. For example, the controller 90 adjusts a flow rate of ammonia supplied to the corresponding burner 45 by controlling a degree of opening of the valve V3 based on a detection result of at least one of the first sensor Se1, the second sensor Se2, the third sensor Se3 and the fourth sensor Se4.

Each burner 45 is connected to the above-described piping P23. Each burner 45 is provided with the hydrogen-rich gas from the cracker 3 via the piping P23. Each pipe P23 is provided with a valve V4. The valves V4 are communicatively connected to the controller 90 by wire or wirelessly, and controlled by the controller 90. For example, the controller 90 adjusts a flow rate of the hydrogen-rich gas supplied to the corresponding burner 45 by controlling a degree of opening of the valve V4 based on a detection result of at least one of the first sensor Se1, the second sensor Se2, the third sensor Se3 and the fourth sensor Se4.

Each burner 45 is connected to piping P24. Each burner 45 is provided with compressed air from the compressor 41 via the piping P24.

In the chamber C, a mixture of ammonia and the hydrogen-rich gas is combusted. Referring to FIG. 1, exhaust gas generated by the combustion is supplied from the combustor 42 to the turbine 43. The turbine 43 is rotated by the exhaust gas. In the present embodiment, rotational power of the turbine 43 is used to operate the generator 5. In another embodiment, the rotational power of the turbine 43 may be used in another equipment.

Piping P3 is connected to the turbine 43. The exhaust gas is supplied from the turbine 43 via the piping P3 to other facilities located downstream of the turbine 43, such as a heat recovery steam generator and a denitrification device (not shown).

In general, the combustion rate of ammonia is slow. Accordingly, when only ammonia is combusted in the chamber C, the combustion in the chamber C is likely to be unstable. However, in the present embodiment, a part of ammonia from the tank 1 is decomposed into hydrogen and nitrogen in the cracker 3, and supplied to the combustor 42. Since the combustion rate of hydrogen is faster, the combustion in the chamber C is stabilized, and an amount of ammonia that can be combusted also increases. Accordingly, ammonia remaining in the exhaust gas from the combustor 42 due to various factors (e.g., unreacted ammonia in the cracker 3 and unburned ammonia in the combustor 42) is reduced. As a result, for example, the operating cost of the denitrification device is reduced.

Furthermore, as mentioned above, a part of ammonia from the tank 1 is decomposed into hydrogen and nitrogen in the cracker 3, and supplied to the chamber C, in the present embodiment. In this case, nitrogen atoms N combine to form nitrogen molecules N₂ in an environment in the section from the cracker 3 to the combustor 42 where there are no or few oxygen atoms O. Nitrogen molecule N₂ is stable and is less likely to combine with oxygen atom O, compared to nitrogen atom N. Accordingly, the formation of NOx, especially the formation of fuel NOx, is curbed.

However, as mentioned above, the combustion rate of hydrogen is faster. Accordingly, when an amount of hydrogen-rich gas from the cracker 3 to the combustor 42 increases, a combustion rate in the chamber C increases, and a flame is likely to move to a position upstream of an intended position. Thus, an excessive increase in the amount of hydrogen-rich gas from the cracker 3 to the combustor 42 may lead to a backfire.

Furthermore, when the amount of hydrogen-rich gas from the cracker 3 to the combustor 42 increases, the combustion in the chamber C is expanded due to the higher combustion rate of hydrogen. Accordingly, internal pressure in the chamber C increases. In this case, fuel from the burners 45 has to push back the higher internal pressure, making it difficult to be injected. As a result, an amount of fuel injected into the chamber C is reduced, making the combustion smaller. Accordingly, the internal pressure in the chamber C decreases. As a result, the increase and the decrease of the internal pressure in the chamber C are alternately repeated. As such, an excessive increase in the hydrogen-rich gas from the cracker 3 to the combustor 42 may lead to a combustion oscillation.

In the present embodiment, combustion abnormalities such as a backfire, a combustion oscillation, an increase in NOx in the exhaust gas, and an increase in ammonia in the exhaust gas are curbed by adjusting the amount of hydrogen-rich gas from the cracker 3 to the combustor 42 and operations of the plurality of burners 45, as described below in more detail.

The system 100 includes a sensor Se configured to detect a combustion anomality in the combustor 42. Specifically, the sensor Se includes the first sensor Se1, the second sensor Se2, the third sensor Se3, and the fourth sensor Se4. In another embodiment, the sensor Se may not include a part of the first sensor Se1, the second sensor Se2, the third sensor Se3, and the fourth sensor Se4.

Referring to FIG. 2, the first sensor Se1 is provided in the combustor 42. The first sensor Se1 is configured to detect a combustion oscillation in the chamber C. For example, the first sensor Se1 can be attached to a wall of the casing 44 or a liner. For example, the first sensor Se1 may be a pressure sensor. The first sensor Se1 is communicatively connected to the controller 90 by wire or wirelessly, and transmits detection data to the controller 90. The controller 90 can detect a combustion oscillation by detecting a pressure fluctuation in the chamber C.

The second sensor Se2 is provided in the combustor 42. The second sensor Se2 is configured to detect a movement of a flame in the chamber C. Specifically, the second sensor Se2 is configured to detect a movement of the flame in the chamber C to a position upstream of an intended position. For example, the second sensor Se2 may include a temperature sensor provided around an injection port of each burner 45. The second sensor Se2 is communicatively connected to the controller 90 by wire or wirelessly, and transmits detection data to the controller 90. The controller 90 can detect approach of the flame to the corresponding burner 45 by detecting a temperature rise around the injection port of the burner 45. Alternatively, the second sensor Se2 may be an optical sensor that can detect the flame.

Referring to FIG. 1, the third sensor Se3 is provided in the piping P3. In another embodiment, the third sensor Se3 may be provided at another location downstream of the combustor 42. For example, the third sensor Se3 can be a NOx sensor that detects a concentration of NOx in the exhaust gas. The third sensor Se3 is communicatively connected to the controller 90 by wire or wirelessly, and transmits detection data to the controller 90.

The fourth sensor Se4 is provided in the piping P3. In another embodiment, the fourth sensor Se4 may be provided at another location downstream of the combustor 42. The fourth sensor Se4 can be an ammonia sensor that detects a concentration of ammonia in the exhaust gas. The fourth sensor Se4 is communicatively connected to the controller 90 by wire or wirelessly, and transmits detection data to the controller 90.

The controller 90 controls the system 100 in whole or in part. For example, the controller 90 may include one or more PCs. For example, the controller 90 includes components such as a processor 90a, a memory 90b, and a connector 90c, and these components are connected to each other via buses. For example, the processor 90a includes a CPU (Central Processing Unit) or the like. For example, the memory 90b includes a hard disk, a ROM in which programs and the like are stored, and a RAM as a work area. The controller 90 is communicatively connected to each component of the system 100 by wire or wirelessly via the connector 90c. For example, the controller 90 may further include other components, such as a display such as an LCD display or a touch panel, and an input device such as a keyboard, a button or a touch panel, etc. For example, the following operations of the controller 90 may be realized by executing programs stored in the memory 90b on the processor 90a.

Next, operations of the system 100 will be described.

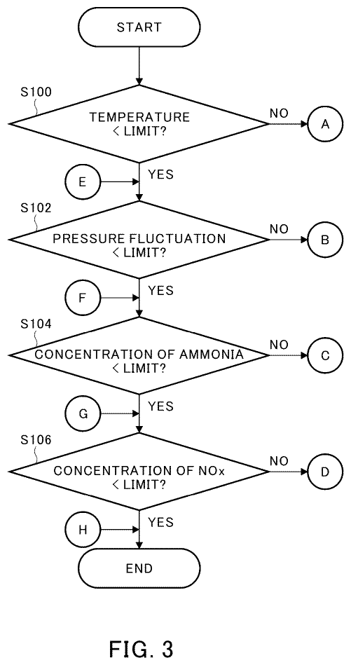

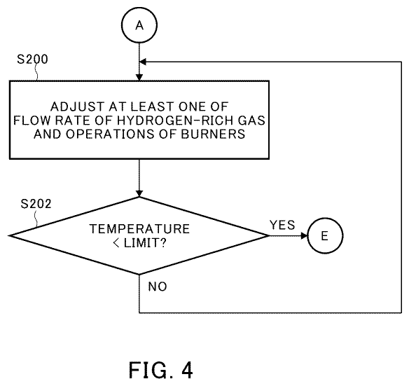

FIG. 3 is a flowchart showing operations of the gas turbine system 100 in FIG. 1. FIGS. 4 through 7 are flowcharts following FIG. 3. For example, operations shown in FIGS. 3 through 7 may be repeated at predetermined intervals while the gas turbine system 100 is in operation.

Referring to FIG. 3, the processor 90a of the controller 90 determines whether or not a temperature detected by each second sensor Se2 is less than a predetermined limit (step S100). For example, the limit for temperature may be determined by an experiment or an analysis as a maximum value at which the flame is allowed to approach each burner 45 in the chamber C, and may be stored in the memory 90b. Alternatively, when an optical sensor is used as the second sensor Se2, step S100 may determine whether or not a position of the flame detected by the second sensor Se2 is within a predetermined range. The predetermined range may be determined by an experiment or an analysis as a range within which the flame is allowed to be present in the chamber C, and may be stored in the memory 90b.

In step S100, when the temperature detected by each second sensor Se2 is less than the limit (YES), the processor 90a proceeds to step S102.

In step S100, when the temperature detected by either second sensor Se2 is equal to or above the limit (NO), the processor 90a proceeds to (A), operations shown in FIG. 4.

Referring to FIG. 4, the processor 90a adjusts at least one of the flow rate of the hydrogen-rich gas from the cracker 3 to the combustor 42 and operations of the burners 45 (step S200).

Referring to FIG. 1, for example, the processor 90a may reduce an amount of ammonia supplied to the cracker 3 by controlling the degree of opening of the valve V2. In this case, the amount of hydrogen-rich gas generated in the cracker 3 is reduced. Accordingly, an amount of hydrogen supplied from the cracker 3 to the combustor 42 is reduced and the combustion rate in the chamber C is reduced. As such, the flame moves to a downstream side and moves away from the burner 45. As a result, a backfire is prevented.

Referring to FIG. 2, alternatively or additionally, for example, the processor 90a may adjust operation of at least one of the plurality of burners 45. For example, the processor 90a may open the valve V3 and the valve V4 of an unused burner 45 among the plurality of burners 45, and may start using this burner 45. In other words, a part of fuel supplied to the burners 45 in use is allocated to the unused burner 45. In this case, an amount of hydrogen supplied to the burner 45 corresponding to the second sensor Se2 that has detected the temperature equal to or above the limit is reduced, and the combustion rate around this burner 45 is reduced. Accordingly, the flame moves to a downstream side and moves away from the corresponding burner 45. As a result, a backfire is prevented.

Referring to FIG. 4, the processor 90a determines again whether or not the temperature detected by each second sensor Se2 is less than the limit (step S202).

In step S202, when the temperature detected by each second sensor Se2 is less than the limit (YES), the processor 90a proceeds to (E), step S102 in FIG. 3.

In step S202, when the temperature detected by either second sensor Se2 is equal to or above the limit (NO), the processor 90a repeats the operations shown in FIG. 4.

Referring to FIG. 3, the processor 90a determines whether or not a pressure fluctuation detected by the first sensor Se1 is less than a predetermined limit (step S102).

The pressure fluctuation may be calculated in a variety of ways. For example, the pressure fluctuation may be calculated as a difference between a maximum pressure value and a minimum pressure value over a predetermined period of time. The pressure fluctuation is not limited thereto, and may be calculated in other various ways. For example, the limit for the pressure fluctuation may be determined by an experiment or an analysis as a maximum value of an acceptable combustion oscillation, and may be stored in the memory 90b.

In step S102, when the pressure fluctuation is less than the limit (YES), the processor 90a proceeds to step S104.

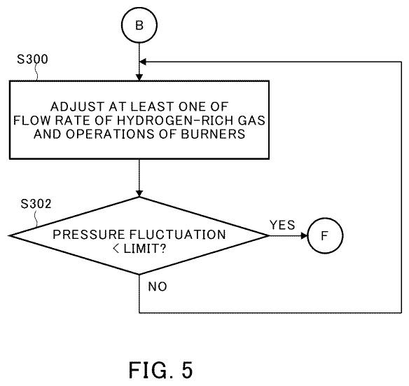

In step S102, when the pressure fluctuation is equal to or above the limit (NO), the processor 90a proceeds to (B), operations shown in FIG. 5.

Referring to FIG. 5, the processor 90a adjusts at least one of the flow rate of the hydrogen-rich gas from the cracker 3 to the combustor 42 and operations of the burners 45 (step S300).

Referring to FIG. 1, for example, the processor 90a may adjust the amount of ammonia supplied to the cracker 3 by controlling the degree of opening of the valve V2. In this case, the amount of hydrogen-rich gas generated in the cracker 3 is changed. Accordingly, the amount of hydrogen supplied from the cracker 3 to the combustor 42 changes, and the combustion rate in the chamber C also changes. As a result, a combustion state in the chamber C changes and a pressure state also changes. This also stabilizes the injection of fuel from the burners 45 into the chamber C. Accordingly, a combustion oscillation is prevented.

Referring to FIG. 2, alternatively or additionally, for example, the processor 90a may adjust operation of at least one of the plurality of burners 45. For example, the processor 90a may open the valve V3 and the valve V4 of an unused burner 45 among the plurality of burners 45, and may start using this burner 45. In other words, a part of fuel supplied to the burners 45 in use is allocated to the unused burner 45. In this case, an amount of hydrogen supplied to one burner 45 is reduced, making the combustion around the burners 45 in use smaller. As a result, pressure around the burners 45 in use is stabilized, and the injection of fuel from the burners 45 into the chamber C is also stabilized. Accordingly, a combustion oscillation is prevented.

Referring to FIG. 5, the processor 90a determines again whether or not the pressure fluctuation is less than the limit (step S302).

In step S302, when the pressure fluctuation is less than the limit (YES), the processor 90a proceeds to (F), step S104 in FIG. 3.

In step S302, when the pressure fluctuation is equal to or above the limit (NO), the processor 90a repeats the operations shown in FIG. 5.

Referring to FIG. 3, the processor 90a determines whether or not a concentration of ammonia detected by the fourth sensor Se4 is less than a predetermined limit (step S104). For example, the limit for ammonia may be determined based on a law, and may be stored in the memory 90b.

In step S104, when the concentration of ammonia is less than the limit (YES), the processor 90a proceeds to step S106.

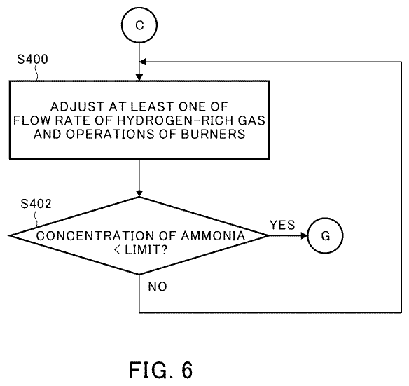

In step S104, when the concentration of ammonia is equal to or above the limit (NO), the processor 90a proceeds to (C), operations shown in FIG. 6.

Referring to FIG. 6, the processor 90a adjusts at least one of the flow rate of the hydrogen-rich gas from the cracker 3 to the combustor 42 and operations of the burners 45 (step S400).

Referring to FIG. 1, for example, the processor 90a may increase the amount of ammonia supplied to the cracker 3 by controlling the degree of opening of the valve V2. In this case, the amount of hydrogen-rich gas generated in the cracker 3 increases. Accordingly, the amount of hydrogen supplied from the cracker 3 to the combustor 42 increases, and the combustion in the chamber C is stabilized. As a result, the amount of ammonia that can be combusted also increases. As such, ammonia in the exhaust gas is reduced.

Referring to FIG. 2, alternatively or additionally, for example, the processor 90a may adjust operation of at least one of the plurality of burners 45. For example, the processor 90a may close the valve V3 and the valve V4 of a part of the burners 45 in use, and may stop the use of this burner 45. In other words, fuel supplied to the part of the burners 45 in use is allocated to the other burners 45 in use. In this case, the amount of hydrogen supplied to one burner 45 increases, and the combustion around the burners 45 in use is stabilized. As a result, the amount of ammonia that can be combusted also increases. As such, the amount of ammonia in the exhaust gas is reduced.

Referring to FIG. 6, the processor 90a determines again whether or not the concentration of ammonia is less than the limit (step S402).

In step S402, when the concentration of ammonia is less than the limit (YES), the processor 90a proceeds to (G), step S106 in FIG. 3.

In step S402, when the concentration of ammonia is equal to or above the limit (NO), the processor 90a repeats the operations shown in FIG. 6.

Referring to FIG. 3, the processor 90a determines whether or not a concentration of NOx detected by the third sensor Se3 is less than a predetermined limit (step S106). For example, the limit for NOx may be determined based on a law, and may be stored in the memory 90b.

In step S106, when the concentration of NOx is less than the limit (YES), the processor 90a completes the series of operations.

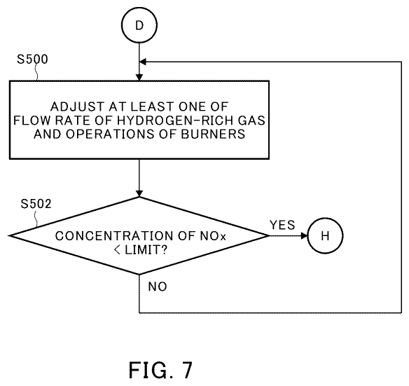

In step S106, when the concentration of NOx is equal to or above the limit (NO), the processor 90a proceeds to (D), operations shown in FIG. 7.

Referring to FIG. 7, the processor 90a adjusts at least one of the flow rate of the hydrogen-rich gas from the cracker 3 to the combustor 42 and operations of the burners 45 (step S500).

Referring to FIG. 1, for example, the processor 90a may increase the amount of ammonia supplied to the cracker 3 by controlling the degree of opening of the valve V2. In this case, a ratio of ammonia decomposed in the cracker 3 to the total ammonia from the tank 1 increases. In this case, more nitrogen atoms N of ammonia combine to form nitrogen molecules N₂ in the environment where there are no or few oxygen atoms O in the section from the cracker 3 to the combustor 42. Nitrogen molecules N₂ are stable and are less likely to combine with oxygen atom O, compared to nitrogen atom N in the ammonia molecules supplied directly to the combustor 42. Accordingly, the formation of NOx, especially the formation of fuel NOx, is curbed.

Referring to FIG. 2, alternatively or additionally, for example, the processor 90a may adjust operation of at least one of the plurality of burners 45. For example, the processor 90a may open the valve V3 and the valve V4 of an unused burner 45 among the plurality of burners 45, and may start using this burner 45. In other words, a part of fuel supplied to the burner 45 in use is allocated to the unused burner 45. In this case, an amount of fuel supplied to one burner 45 is reduced, making the combustion temperature around the burners 45 in use lower. As a result, the formation of NOx around the burners 45 in use, especially the formation of thermal NOx, is reduced.

Referring to FIG. 7, the processor 90a determines again whether or not the concentration of NOx is less than the limit (step S502).

In step S502, when the concentration of NOx is less than the limit (YES), the processor 90a terminates the series of operations (H).

In step S502, when the concentration of NOx is equal to or above the limit (NO), the processor 90a repeats the operations shown in FIG. 7.

The system 100 as described above includes the tank 1 that stores ammonia, the cracker 3 that is connected to the tank 1 and that decomposes ammonia into hydrogen and nitrogen, the combustor 42 that is fluidly connected to the tank 1 and the cracker 3 and that combusts ammonia from the tank 1 and the hydrogen-rich gas from the cracker 3, a sensor Se that detects a combustion abnormality in the combustor (a backfire, a combustion oscillation, an increase in NOx in the exhaust gas, and an increase in ammonia in the exhaust gas), and the controller 90 that is communicatively connected to the sensor Se and that adjusts the amount of hydrogen-rich gas from the cracker 3 to the combustor 42 based on a detection result of the sensor Se. According to such a configuration, the amount of hydrogen from the cracker 3 to the combustor 42 is adjusted based on the detection result of the sensor Se when a combustion abnormality is detected, and the rate and the size of the combustion in the chamber C are controlled. Thus, the combustion abnormality can be prevented. Furthermore, in Patent Literature 1, for example, the second combustion chamber is provided to remove NOx from the exhaust gas from the first combustion chamber, as described above. However, in the system 100, there is no need to provide an additional combustor exclusively used for NOx removal. Therefore, the above configuration allows the system to be downsized.

Furthermore, in the system 100, the sensor Se includes the first sensor Se1 that is provided in the combustor 42 and that detects a combustion oscillation. According to such a configuration, a combustion oscillation in the combustor 42 can be prevented.

Furthermore, in the system 100, the sensor Se includes the second sensor Se2 that is provided in the combustor 42 and that detects a movement of a flame. According to such a configuration, a backfire in the combustor 42 can be prevented.

Furthermore, in the system 100, the sensor Se includes the third sensor Se3 that detects NOx in the exhaust gas at a location downstream of the combustor 42. According to such a configuration, an increase in NOx in the exhaust gas can be prevented.

Furthermore, in the system 100, the sensor Se includes the fourth sensor Se4 that detects ammonia in the exhaust gas at a location downstream of the combustor 42. According to such a configuration, an increase in ammonia in the exhaust gas can be prevented.

Furthermore, in the system 100, the combustor 42 includes the plurality of burners 45, and the controller 90 controls operations of the plurality of burners 45 based on a detection result of the sensors Se. According to such a configuration, the speed and the size of the combustion in the chamber C can be controlled in more detail. Thus, a combustion abnormality can be further prevented.

Next, a system according to another embodiment will be described.

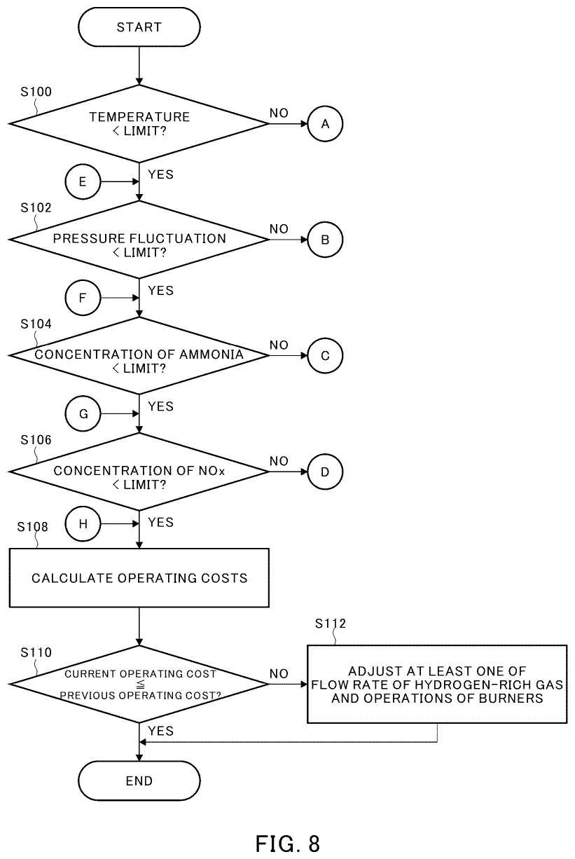

FIG. 8 is a flowchart showing operations of a gas turbine system 100 according to a second embodiment. The system 100 of the second embodiment differs from the system 100 of the first embodiment in that the processor 90a further executes step S108, step S110, and step S112. In other configurations, the system 100 of the second embodiment may be the same as the system 100 of the first embodiment.

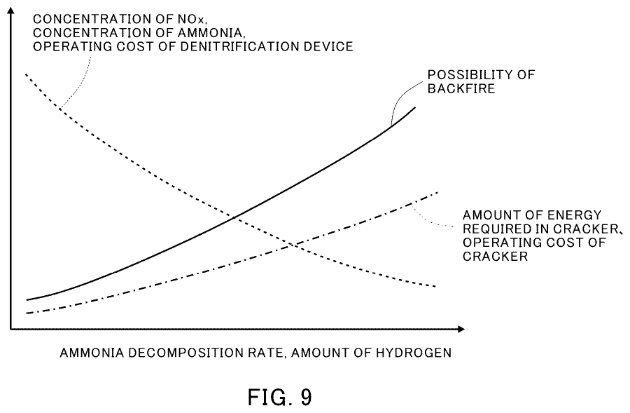

FIG. 9 is a schematic graph showing relationships between an ammonia decomposition rate and each parameter. In FIG. 9, the horizontal axis indicates a ratio of ammonia decomposed in the cracker 3 to the total ammonia from the tank 1. The horizontal axis also corresponds to the amount of hydrogen supplied from the cracker 3 to the combustor 42, since the amount of hydrogen supplied from the cracker 3 to the combustor 42 is proportional to the ammonia decomposition rate. A solid line indicates a possibility of backfire. Since the possibility of backfire is proportional to a temperature of an area where the temperature is lower during a normal operation but the temperature is higher during an occurrence of backfire or approach of a flame moving to an upstream side, the solid line also corresponds to the temperature of such an area. A dashed line indicates the concentration of NOx and the concentration of ammonia in the exhaust gas. The dashed line also corresponds to an operating cost of the denitrification device, since the operating cost of the denitrification device is proportional to the concentration of ammonia in the exhaust gas. A dashed-dotted line indicates an amount of energy required to decompose ammonia in the cracker 3. Since the decomposition of ammonia is an endothermic reaction, energy is required. Furthermore, when energy is obtained from outside the system 100, an operating cost of the cracker 3 is proportional to the amount of energy. Accordingly, the dashed-dotted line also corresponds to the operating cost of the cracker 3.

As shown in FIG. 9, in a region where the ammonia decomposition rate is lower, the possibility of a backfire is lower and the operating cost of the cracker 3 is also lower. In contrast, in this region, the concentration of NOx and the concentration of ammonia are higher, and therefore the operating cost of the denitrification device is also higher. In a region where the ammonia decomposition rate is higher, the possibility of a backfire is higher and the operating cost of the cracker 3 is also higher. In contrast, in this region, the concentration of NOx and the concentration of ammonia are lower, and therefore the operating cost of the denitrification device is also lower. For example, the controller 90 may control the ammonia decomposition rate so that at least one cost parameter in the system 100 is maintained lower to the extent that a backfire does not occur. The parameters considered in the controller 90 are not limited to those shown in FIG. 9, and the controller 90 may be configured to further consider other parameters.

For example, in FIG. 8, the processor 90a calculates the operating costs of the cracker 3 and the denitrification device (not shown) after the operations shown in FIGS. 3 through 7 (step S108). As described above, for example, these operating costs may be calculated based on the ammonia decomposition rate (or an amount of ammonia to be decomposed).

The processor 90a determines whether the current total operating cost is less than or equal to the previous total operating cost (step S110). For example, the previous operating cost may be stored in the memory 90b.

In step S110, when the current total operating cost is less than or equal to the previous total operating cost (YES), the processor 90a completes the series of operations.

In step S110, when the current total operating cost is higher than the previous total operating cost (NO), the processor 90a adjusts at least one of the flow rate of the hydrogen-rich gas from the cracker 3 to the combustor 42 and operations of the burners 45 so that the total operating cost is reduced (step S112), and terminates the series of operations.

The system 100 of the second embodiment as described above has effects similar to those of the system 100 of the first embodiment. Especially, the second embodiment can take into account the operating cost of the system 100.

Although the embodiments of the present disclosure have been described above with reference to the accompanying drawings, the present disclosure is not limited thereto. It is obvious that a person skilled in the art can conceive of various examples of variations or modifications within the scope of the claims, which are also understood to belong to the technical scope of the present disclosure.

For example, in the above embodiments, the gas turbine system 100 functions as the combustion system. In another embodiment, the combustion system may be applied to another system that uses ammonia as fuel. For example, the combustion system may be applied to a steam turbine system.

In this case, the steam turbine system may include a boiler that combusts ammonia, and a steam turbine that is operated by steam generated by the boiler. In this case, the combustion system includes a combustor of the boiler, instead of the above-described combustor 42 of the gas turbine 4.

The present disclosure can promote the use of ammonia to reduce CO₂ emissions, thus contributing to Sustainable Development Goals (SDGs), Goal 7 “Ensure access to affordable, reliable, sustainable and modern energy,” and Goal 13 “Take urgent action to combat climate change and its impacts,” for example.

What is claimed is:

1. A combustion system comprising:
an ammonia supply source;
a cracker that is connected to the ammonia supply source and that decomposes ammonia into hydrogen and nitrogen;
a combustor that is connected to the ammonia supply source and the cracker and that combusts ammonia from the ammonia supply source and gas including hydrogen from the cracker;
a sensor that detects a combustion abnormality in the combustor; and
a controller that is communicatively connected to the sensor and that adjusts an amount of gas from the cracker to the combustor based on a detection result of the sensor wherein the sensor includes a pressure sensor that is provided in the combustor and that detects a combustion oscillation.

2. The combustion system according to claim 1, wherein the sensor includes a second sensor that is provided in the combustor and that detects a movement of a flame.

3. The combustion system according to claim 1, wherein the sensor includes a third sensor that detects NOx in exhaust gas at a location downstream of the combustor.

4. The combustion system according to claim 1, wherein the sensor includes a fourth sensor that detects ammonia in exhaust gas at a location downstream of the combustor.

5. The combustion system according to claim 1, wherein the combustor includes a plurality of burners, and
the controller controls operations of the plurality of burners based on the detection result of the sensor.

6. A combustion system comprising:
an ammonia supply source;
a cracker that is connected to the ammonia supply source and that decomposes ammonia into hydrogen and nitrogen;
a combustor that is connected to the ammonia supply source and the cracker and that combusts ammonia from the ammonia supply source and gas including hydrogen from the cracker;
a sensor that detects a combustion abnormality in the combustor; and
a controller that is communicatively connected to the sensor and that adjusts an amount of gas from the cracker to the combustor based on a detection result of the sensor
wherein the sensor includes a temperature sensor that is provided in the combustor and that detects a backfire.

7. The combustion system according to claim 6, wherein the sensor includes a second sensor that is provided in the combustor and that detects a combustion oscillation.

8. The combustion system according to claim 6, wherein the sensor includes a third sensor that detects NOx in exhaust gas at a location downstream of the combustor.

9. The combustion system according to claim 6, wherein the sensor includes a fourth sensor that detects ammonia in exhaust gas at a location downstream of the combustor.

10. The combustion system according to claim 6, wherein the combustor includes a plurality of burners, and
the controller controls operations of the plurality of burners based on the detection result of the sensor.

11. A combustion system comprising:
an ammonia supply source;
a cracker that is connected to the ammonia supply source and that decomposes ammonia into hydrogen and nitrogen;
a combustor that is connected to the ammonia supply source and the cracker and that combusts ammonia from the ammonia supply source and gas including hydrogen from the cracker;
a sensor that detects a combustion abnormality in the combustor; and
a controller that is communicatively connected to the sensor and that adjusts an amount of gas from the cracker to the combustor based on a detection result of the sensor
wherein the sensor includes a NOx sensor that detects NOx in exhaust gas at a location downstream of the combustor.

12. The combustion system according to claim 11, wherein the sensor includes a second sensor that is provided in the combustor and that detects a combustion oscillation.

13. The combustion system according to claim 11, wherein the sensor includes a third sensor that is provided in the combustor and that detects a movement of a flame.

14. The combustion system according to claim 11, wherein the sensor includes a fourth sensor that detects ammonia in exhaust gas at a location downstream of the combustor.

15. The combustion system according to claim 11, wherein the combustor includes a plurality of burners, and
the controller controls operations of the plurality of burners based on the detection result of the sensor.
